(19) United States
(12) Patent Application Publication
(10) Pub. No.: US 2026/0303767 A1
(43) Pub. Date: Oct. 1, 2026

(54) DIGITAL HOLOGRAPHIC DISPLAY SYSTEM

(71) Applicant: Creativemut Co., Ltd., Seoul (KR)

(72) Inventors: Tae Hwan KIM, Seoul (KR); Jong Whan MYOUNG, Incheon (KR)

(73) Assignee: Creativemut Co., Ltd., Seoul (KR)

(21) Appl. No.: 19/574,803

(22) Filed: Mar. 23, 2026

(30) Foreign Application Priority Data
Mar. 25, 2025 (KR) 10-2025-0038168

(51) Int. Cl. H04N 13/111; G02B 30/00; H04N 13/189; H04N 13/194; H04N 13/302; H04N 13/398

(52) U.S. Cl. CPC H04N 13/111; G02B 30/00; H04N 13/189; H04N 13/194; H04N 13/302; H04N 13/398

(57) ABSTRACT

Disclosed is a digital holographic display system. A digital holographic display system according to an embodiment of the present invention includes a data input unit configured to accommodate image and video data input according to a user's intention and transmit the accommodated image and video data to a pattern conversion unit, the pattern conversion unit configured to calculate pattern data for a stereoscopic image corresponding to the accommodated data and transmit the calculated pattern data to a stereoscopic video output unit in real time, and the stereoscopic video output unit configured to form a pattern on a display panel according to the pattern data transmitted in real time from the pattern conversion unit and provide backlight to the display panel to implement a three-dimensional (3D) stereoscopic video. According to the present invention, real-time 3D conversion performance is improved, compatibility is improved to handle various types of input data, and a pattern conversion speed is maximized by applying high-speed parallel computing. Further, a stereoscopic effect and color expression are enhanced through a multi-layer pattern structure and local dimming function, and maintenance and upgrades become easier by applying a modular design. Accordingly, it is possible to implement immersive 3D videos, and the present invention may be effectively utilized in various industrial and consumer environments.

### CROSS-REFERENCE TO RELATED APPLICATION

This application claims priority to and the benefit of Korean Patent Application No. 10-2025-0038168, filed on Mar. 25, 2025, the disclosure of which is incorporated herein by reference in its entirety.

### BACKGROUND

### 1. Field of the Invention

The present invention relates to a digital holographic display system, and more particularly, to a digital holographic display system capable of outputting a three-dimensional stereoscopic video upon input of stereoscopic images to be generated in real time.

### 2. Discussion of Related Art

Digital holographic display technologies have evolved to generate three-dimensional (3D) images. Early 3D display technologies required special glasses to provide a stereoscopic effect, and this approach has been an element that limits the user experience. In particular, the glasses-wearing method causes fatigue when used for long periods of time and causes discomfort when viewing content with a plurality of users. Accordingly, digital holographic technology that can generate glasses-free stereoscopic videos, but various problems are present according to the implementation method.

Conventional digital holographic display systems mainly output pre-generated 3D data. Since this method may only output videos when there is prepared holographic data, it is difficult to reflect videos that change in real time or immediate content desired by users. Some technologies in which real-time captured videos are converted into holograms and the converted holograms are output have been developed, but a slow data processing speed has limited the immediate implementation of 3D videos.

The problem of data processing speed that occurs during a process of converting video data into 3D patterns is an important element that hinders the implementation of real-time display. Since digital holographic videos require high resolution and a large amount of data processing, immediate video implementation is impossible when there is a delay in the process from data input to output. Conventional systems have adopted a method of using pre-calculated pattern data to solve these problems, but this approach has limitations in real-time video conversion and dynamic content output.

Further, conventional holographic display systems often only operate on specific devices according to the type of input data. For example, systems designed to process only videos or images in specific formats may lower user convenience. The conventional systems are designed to mainly process stored static images or videos in specific file formats, and thus it is difficult to utilize various input sources. In particular, the usability is limited because a function to directly convert and output real-time captured video or broadcast data is insufficient.

Connectivity with a video recording device is also pointed out as a problem in conventional digital holographic display systems. In general, in order to output 3D videos, a separate recording device and software should be used to convert the videos and then input the converted videos into the display system. This process is structured in a way that is difficult for general users without specialized knowledge to access and is ineffective in environments that require immediate video output. The conventional system has the inconvenience of requiring users to go through a separate video conversion operation, and it is difficult to implement real-time videos due to the lack of an automatic conversion function.

The method of expressing a stereoscopic effect performed by the conventional digital holographic display system also has limitations. Some systems utilize multi-layer panels to achieve a 3D effect, but this method has a limited field of view and may only perceive a stereoscopic effect properly at certain angles. In particular, when a 3D effect is implemented through a combination of a display panel and a backlight, videos may be distorted or not displayed properly according to the user's position. These limitations reduce immersion and limit the user experience.

Further, the conventional systems have high technological barriers to entry in the process of creating holographic content. In order to generate 3D video content, an expensive device and specialized software are required, and thus it is difficult for general users to generate or convert content themselves. Due to these issues, digital holographic displays remain a technology available only to certain experts and institutions, and their widespread adoption is limited.

The conventional digital holographic display systems also have problems with maintenance and expandability. When a display panel and a backlight are designed as an integrated unit, it is difficult to replace or upgrade some components, and the system, which operates only in a specific hardware environment, has limited expandability as technology advances in the future. Further, lack of a function for improving display performance or supporting user-customized settings makes it difficult to utilize in various environments.

A function to convert video data through real-time broadcasting or networks into holographic videos is also inadequate in the conventional systems. Since the conventional systems mainly utilize stored data, it is difficult to immediately convert live streaming data or online content into 3D videos. Due to these issues, the digital holographic display systems have limitations in that they are not closely linked to broadcast and online content consumption methods.

In this way, the conventional technologies have problems such as limitations in real-time video conversion speed, compatibility issues with input data, lack of connectivity with a shooting device, limitations in implementing a stereoscopic effect, difficulties in maintenance, high barriers to content creation, etc. Failure to address these problems may inevitably limit the widespread adoption of the digital holographic display technology. The present invention aims to solve the problems of conventional technologies and provide a digital holographic display system capable of real-time 3D video conversion.

### RELATED ART DOCUMENT

### Patent Document

(Patent Document 1) Korean Patent Registration No. 10-1898490 (Registration date: Sep. 7, 2018)

### SUMMARY OF THE INVENTION

The present invention is directed to providing a digital holographic display system capable of easily outputting a three-dimensional (3D) stereoscopic video intended to be implemented after inputting an image prepared according to a user or operator's intentions, outputting a 3D stereoscopic image or video intended to be implemented upon photographing or video recording, outputting a 3D stereoscopic video upon loading a pre-stored image or video, and outputting a 3D stereoscopic video upon input of image and video data received through real-time broadcasting, thereby allowing a user to easily view a 3D stereoscopic video without the help of an expert in digital holography.

According to an aspect of the present invention, there is provided a digital holographic display system, which includes a data input unit configured to accommodate image and video data input according to a user's intention and transmit the accommodated image and video data to a pattern conversion unit, the pattern conversion unit configured to calculate pattern data for a stereoscopic image corresponding to the accommodated data and transmit the calculated pattern data to a stereoscopic video output unit in real time, and the stereoscopic video output unit configured to form a pattern on a display panel according to the pattern data transmitted in real time from the pattern conversion unit and provide backlight to the display panel to implement a 3D stereoscopic video.

The data input unit may include a captured data accommodating unit that accommodates data captured through the user's video detection sensor, camera, camcorder, shooting device, closed-circuit television (CCTV), or video recording device and transmits the accommodated data to the pattern conversion unit through a wired transmission cable or a wireless communication module, a stored data accommodating unit that accommodates image and video data through the user's data storage medium or data storage device and a wired transmission cable or a wireless communication module and transmits the accommodated image and video data to the pattern conversion unit, and a broadcast data accommodating unit that is connected to a broadcast medium or broadcast output device set or connected by the user through a wired transmission cable or a wireless communication module and accommodates the image and video data received in real time from the connected broadcast medium or broadcast output device to transmit the accommodated image and video data to the pattern conversion unit.

The pattern conversion unit may include a video frame extraction unit that extracts still images in a preset number of frames per second in a video playback order from the data received from the data input unit, assigns a video playback order-related log to each extracted image, and alternately transmits the extracted still images to which the log is assigned to the first frame pattern calculation unit and the second frame pattern calculation unit at a cycle of one second, a first frame pattern calculation unit that calculates pattern data corresponding to the images transmitted from the video frame extraction unit and transmits the calculated pattern data to the stereoscopic video output unit according to the log, and a second frame pattern calculation unit that calculates pattern data corresponding to the images transmitted from the video frame extraction unit and transmits the calculated pattern data to the stereoscopic video output unit according to the log.

The stereoscopic video output unit may include a display housing, which has a box-shaped structure having an internal accommodating space of a predetermined volume, in which the display panel is detachably mounted on an internal front surface thereof, a backlight is detachably mounted on an internal rear surface thereof, and a structure that allows a mounting structure to change in response to widths and lengths of the display panel and the backlight is embedded, and which has a structure in which the data input unit and the pattern conversion unit are mounted therein, the display panel that is detachably mounted on the internal front surface of the display housing 131 and forms a pattern by sequentially accommodating the pattern data alternately transmitted from the first frame pattern calculation unit and the second frame pattern calculation unit of the pattern conversion unit according to the log, and a light supply unit that is mounted on the internal rear surface of the display housing, sequentially accommodates the pattern data alternately transmitted from the first frame pattern calculation unit and the second frame pattern calculation unit of the pattern conversion unit according to the log, and outputs backlight corresponding to a pattern formed on the display panel to provide the backlight to the display panel.

The display panel may include a main pattern generation panel that is detachably mounted on the internal front surface of the display housing, is placed to overlap an additional pattern generation panel, and sequentially accommodates the pattern data transmitted from the first frame pattern calculation unit according to the log to form a pattern, and the additional pattern generation panel that is detachably mounted on the internal front surface of the display housing, is placed to overlap a rear surface of the main pattern generation panel, and sequentially accommodates the pattern data transmitted from the second frame pattern calculation unit according to the log to form a pattern.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a digital holographic display system according to an embodiment of the present invention;

FIG. 2 is a perspective view illustrating the digital holographic display system according to an embodiment of the present invention;

FIG. 3 is a perspective view illustrating a stereoscopic video output unit of FIG. 2;

FIG. 4 shows a schematic diagram of a spatial light modulator (SLM) applied to a digital holographic display of the digital holographic display system according to an embodiment of the present invention and reproduced images; and

FIG. 5 shows schematic diagrams of the digital holographic display principles of the digital holographic display system according to an embodiment of the present invention.

### DETAILED DESCRIPTION OF EXEMPLARY EMBODIMENTS

Hereinafter, exemplary embodiments of the present invention will be described in detail with reference to the accompanying drawings. Before proceeding, terms and words used in this specification and claims should not be construed as being limited to commonly used meanings or meanings in dictionaries and should be interpreted with meanings and concepts which are consistent with the technological scope of the present invention.

Throughout this specification, when a member is referred to as being located “on” another member, it includes a case in which a member is in contact with the other member and a case in which another member is present between the two members. Throughout this specification, when a certain part “includes” a certain component, it means that another component may be further included not excluding other components unless otherwise stated.

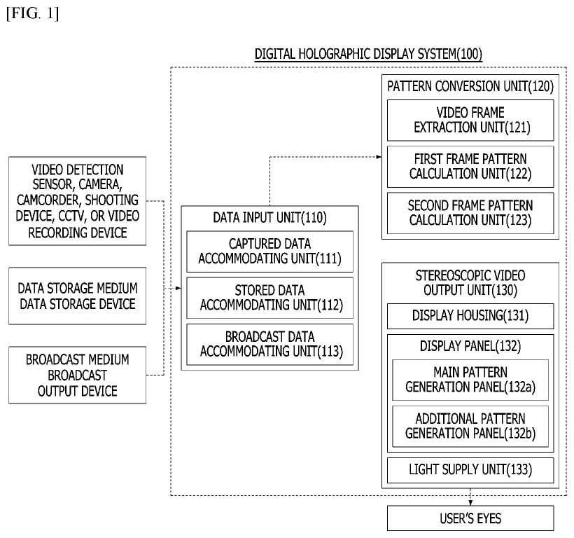

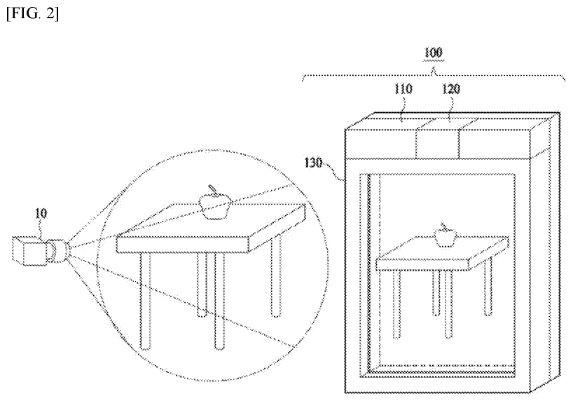

FIG. 1 is a block diagram illustrating a digital holographic display system according to an embodiment of the present invention, and FIG. 2 is a perspective view illustrating the digital holographic display system according to an embodiment of the present invention.

Referring to these drawings, a digital holographic display system 100 according to the present embodiment may include a data input unit 110, a pattern conversion unit 120, and a stereoscopic video output unit 130 of a specific structure, easily output a three-dimensional (3D) stereoscopic video intended to be implemented after inputting an image prepared according to a user or operator's intentions, output a 3D stereoscopic image or video intended to be implemented upon photographing or video recording, output a 3D stereoscopic video upon loading a pre-stored image or video, output a 3D stereoscopic video upon input of image and video data received through real-time broadcasting, and thus a 3D stereoscopic video may be easily provided without the help of an expert in digital holography.

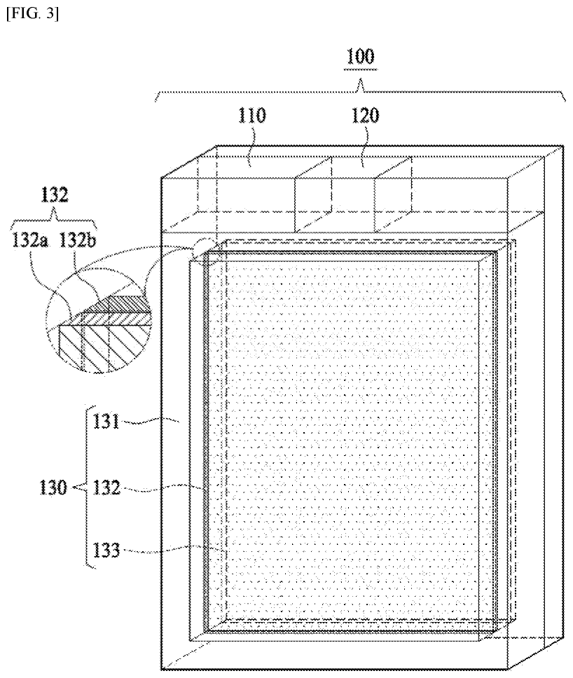

Hereinafter, each component constituting the digital holographic display system 100 according to the present embodiment will be described in detail with reference to FIGS. 1 to 5.

### Specific Configuration and Role of Data Input Unit 110

The data input unit 110 serves to accommodate image and video data input according to a user's intention and transmit the accommodated image and video data to the pattern conversion unit 120. The data input unit 110 is designed to be connected to various input devices and may be formed to efficiently process data provided from the user's shooting device, storage device, real-time broadcast medium, etc. In the present invention, the data input unit 110 may smoothly accommodate and convert real-time video and image data, thereby solving a problem of input data limitation occurring in conventional systems.

The data input unit 110 supports both wired and wireless connection methods to process various types of input data. The wired connection methods may include High-Definition Multimedia Interface (HDMI), Universal Serial Bus (USB), and Ethernet connections, and the wireless connection methods may include Wi-Fi, Bluetooth, 5G networks, etc. Accordingly, users may select an optimal connection method for their environments and freely transmit data without physical connection constraints. In particular, data transmission via wireless networks is advantageous for accommodating real-time broadcast data and user convenience may be maximized.

The data input unit 110 includes a function to automatically analyze the type of data being input and verify whether the data is in an appropriate format. For example, since videos captured by a user with a camera, stored image files, real-time broadcast data, etc., may be present in different formats, the data input unit 110 may identify the codec, resolution, frame rate, etc., of the input data to perform optimal conversion processing. Accordingly, it is possible to maintain the stability of the system and minimize data loss that may occur during the conversion process.

Further, the data input unit 110 may support a multi-input function so that multiple input sources may be processed simultaneously in one system. For example, when a user is desired to load a separately stored image and convert the loaded image into a 3D video while watching a live broadcast, the data input unit 110 may simultaneously accommodate two or more data streams and transmit the accommodated data streams to the pattern conversion unit 120. Such a function expands the multitasking capabilities previously limited by the conventional systems, thereby enabling more efficient implementation of digital holographic videos.

The data input unit 110 may be designed as an expandable modular unit in consideration of compatibility with external devices. The user may connect only a specific input device or mount an additional input module to expand the system's functionality, as necessary. For example, a drone video input module may be additionally mounted in a system that basically supports camera input, and the system may be easily upgraded even when new input technologies emerge in the future.

### Captured Data Accommodating Unit 111

A captured data accommodating unit 111 performs a function to accommodate videos captured in real time by the user using a video recording device such as a camera, a camcorder, a closed-circuit television (CCTV), etc. In the present invention, the captured data accommodating unit 111 may support both a wired transmission cable and a wireless communication module, thereby enabling stable reception of real-time captured videos in various environments. Accordingly, the user may immediately convert a captured video into a 3D stereoscopic video and use the converted stereoscopic video.

The captured data accommodating unit 111 may support a real-time data streaming function and allow the captured video to be immediately transmitted to the pattern conversion unit 120. In conventional digital holographic systems, a separate data conversion process is often required after capturing a video, and thus there was a disadvantage in that it was difficult to utilize in real time. In the present invention, the captured video may be input into the system immediately, and thus the user experience may be significantly improved.

The captured data accommodating unit 111 is designed to support various resolutions and frame rates. Videos captured by users may be present at various resolutions, such as 720 p, 1,080 p, 4 K, and 8 K, and frame rates thereof may vary in the form of 30 fps, 60 fps, and 120 fps. The present invention includes a function to automatically select an optimal video processing method in consideration of these various capturing conditions.

The captured data accommodating unit 111 may utilize an application programming interface (API) or a dedicated driver for direct connection with a shooting device. For example, when the system is connected to a specific brand of camera or drone shooting device, an optimized data transmission method may be applied in consideration of the characteristics of the corresponding device. Accordingly, the captured videos may be input into the system rapidly without data loss while maintaining high quality.

Further, the captured data accommodating unit 111 may support a network-based remote shooting function. The captured data accommodating unit 111 may transmit the videos captured by the user from a remote location in real time so that the videos may be used immediately in the digital holographic display system, and accordingly, the system may be used in various applications such as remote education, live events, real-time surveillance, etc.

### Stored Data Accommodating Unit 112

A stored data accommodating unit 112 serves to accommodate video and image data from the user's data storage medium or storage device and transmit the accommodated video and image data to the pattern conversion unit 120. The user may load existing photographs and video files that are already in storage and immediately convert the loaded photographs and video files into 3D videos using the digital holographic display system.

The stored data accommodating unit 112 is designed to support various file formats. The stored data accommodating unit 112 may process not only general image formats (e.g., JPG, PNG, and BMP) but also various video formats (e.g., MP4, AVI, MKV, and MOV), thereby increasing the user's data utilization. In some conventional systems, data conversion was necessary because only specific formats were supported, but the present invention automatically processes video formats to improve user convenience.

The stored data accommodating unit 112 is designed in consideration of connectivity with external storage devices (e.g., a USB, a secure digital (SD) card, and an external hard drive). The stored data accommodating unit 112 supports various interfaces (e.g., USB 3.0, USB-C, Thunderbolt, and a SD card reader) so that the user may easily load the stored data, and also enables file transfer through a network.

The stored data accommodating unit 112 includes an error detection function to prevent data loss. When a file is damaged or incompatible, the stored data accommodating unit 112 automatically attempts to recover it or provides a guidance message to the user, thereby performing a data protection function.

Further, the stored data accommodating unit 112 may provide a user interface (UI) so that the user may selectively convert a desired video. The user may select a specific section to perform 3D conversion and may also extract and utilize a specific frame as necessary.

### Broadcast Data Accommodating Unit 113

A broadcast data accommodating unit 113 serves to accommodate image and video data received in real time from a broadcast medium or broadcast output device set or connected by the user and transmit the accommodated image and video data to the pattern conversion unit 120. In the conventional digital holographic display systems, since only stored or captured videos are often processed, it was difficult to output 3D videos using real-time broadcasting. In the present invention, the broadcast data accommodating unit 113 may directly receive real-time broadcast data and immediately convert the real-time broadcast data, thereby enabling more dynamic content consumption.

The broadcast data accommodating unit 113 is designed in consideration of compatibility with various broadcast sources. The broadcast data accommodating unit 113 may accommodate not only signals of existing broadcast such as terrestrial televisions (TVs), cable TVs, satellite broadcasting, Internet Protocol televisions (IPTVs), etc., but also real-time streaming data provided by Internet streaming platforms (e.g., YouTube, Netflix, Twitch, etc.). To this end, the broadcast data accommodating unit 113 supports both wired connection methods such as HDMI, radio frequency (RF) antenna input, audio/visual (AV) input, digital optical signal input (TOSLINK), etc., and wireless connection methods such as Wi-Fi, 5G, Bluetooth, etc. Accordingly, the user may easily receive broadcast data appropriate for his/her environment.

The broadcast data accommodating unit 113 performs a function to analyze the received broadcast data and refine the data so that optimal conversion may be performed in the pattern conversion unit 120. The broadcast data is generally provided in various frame rates (e.g., 24 fps, 30 fps, and 60 fps) and resolutions (e.g., 720 p, 1080 p, 4 K, and 8 K), and thus the broadcast data is analyzed and converted in real time to ensure optimal 3D video output. Further, a function to automatically detect advertisements or specific sections included in a broadcast and allow the user to convert only the content he/she wants may be included.

The broadcast data accommodating unit 113 supports a network-based broadcast data reception function. When the user receives real-time streaming videos through the Internet, the broadcast data accommodating unit 113 applies buffering and optimization technology to transmit the data to the pattern conversion unit 120 stably and without interruption. For example, when the user receives high-resolution streaming data, the broadcast data accommodating unit 113 may perform appropriate data compression and decompression according to a network speed to enable real-time data processing.

Further, the broadcast data accommodating unit 113 may be designed to simultaneously accommodate multiple broadcast sources. For example, a multi-channel data reception function for allowing the user to watch a sports broadcast on one screen while converting a news broadcast into a 3D video and outputting it on another screen may be included. Accordingly, the user may simultaneously enjoy various broadcast content and receive a more realistic digital holographic display experience.

### Specific Configuration and Role of Pattern Conversion Unit 120

The pattern conversion unit 120 performs a function to convert the video data received from the data input unit 110 into 3D pattern data and serves to transmit the converted data to the stereoscopic video output unit 130 in real time. The pattern conversion unit 120 of the present invention solves the data processing delay problem in the conventional digital holographic systems, and a high-speed operation structure is applied to enable real-time 3D video conversion. Accordingly, a more intuitive 3D video viewing experience may be provided by immediately converting various types of video data input by the user.

The pattern conversion unit 120 is designed to analyze the characteristics of video data so that an optimal conversion method may be applied. The video data includes various elements, such as a resolution, a frame rate, and color information, etc., and in order to minimize the impact of these elements on 3D pattern conversion, the pattern conversion unit 120 identifies the characteristics of the input data and adjusts a conversion algorithm according to the identified characteristics in real time. For example, in the case of low-resolution videos, the pattern conversion unit 120 performs an upscaling process to compensate for data loss, thereby improving the quality of the converted 3D pattern.

In the pattern conversion unit 120, a parallel computation method may be applied to maximize a data processing speed. In conventional systems, a method of sequentially converting video frames was often applied, and thus there was a problem of delay in the process of converting high-resolution and high-frame rate videos. In the present invention, the pattern conversion unit 120 is designed to divide video frames and process the divided frames in parallel in a plurality of operation modules so that the real-time conversion speed may be significantly improved.

The pattern conversion unit 120 includes a function to organize the converted 3D pattern data based on a log and transmit the data to the stereoscopic video output unit 130. The converted pattern data includes a frame order and time information of the video, and the pattern conversion unit 120 systematically organizes the data by providing log information so that the stereoscopic video output unit 130 may receive the frames in the correct order. Accordingly, it is possible to minimize frame loss or distortion that may occur when 3D videos are output continuously.

Further, the pattern conversion unit 120 may include a function to optimize the converted pattern data according to user settings. For example, when a user activates a stereoscopic effect adjustment function, the pattern conversion unit 120 applies an algorithm for enhancing the stereoscopic effect during the conversion process, thereby implementing a 3D video with a greater sense of depth. Through these user-customizable functions, the optimal digital holographic display experience may be provided in various environments.

### Video Frame Extraction Unit 121

A video frame extraction unit 121 serves to divide the video data received from the data input unit 110 into frame units and process each frame into a form that facilitates pattern conversion. In the present invention, in order to smoothly convert a video, the video frame extraction unit 121 is designed to extract frames at regular intervals, organize the extracted frames, and transmit the organized frames to the pattern conversion unit 120. Accordingly, the input video may be converted into continuous 3D pattern data.

The video frame extraction unit 121 is designed to maintain a constant number of frames regardless of a playback speed of the input video. In general, video content has various frame rates, such as 24 fps, 30 fps, 60 fps, etc., and these differences may cause frame loss or distortion during the conversion process. The video frame extraction unit 121 of the present invention may analyze the frame rate of the input video and extract frames at regular intervals according to the criteria set in the system to transmit the extracted frames to the pattern conversion unit 120.

The video frame extraction unit 121 may generate log data for each frame so that the pattern conversion unit 120 may correctly recognize the frame order. In the present invention, since the pattern conversion is performed based on the log data assigned for each frame, sequentially sorted 3D pattern data may be generated, thereby improving the quality of 3D videos may be improved.

The video frame extraction unit 121 has a plurality of frame extraction paths and alternately transmits data to the first frame pattern calculation unit 122 and the second frame pattern calculation unit 123 of the pattern conversion unit 120 through the plurality of frame extraction paths. In the present invention, the conversion speed may be optimized by distributing frames to two pattern conversion modules to optimize, and accordingly, thereby improving real-time conversion performance.

Further, the video frame extraction unit 121 may include a function capable of extracting a specific section. When a user is desired to convert only a specific section of video, the video frame extraction unit 121 may automatically analyze the frames in the corresponding section, extract only the necessary frames, and transmit the extracted frames to the pattern conversion unit 120. Accordingly, the unnecessary data processing may be minimized, and the computational efficiency of the system may be improved.

### First Frame Pattern Calculation Unit 122

A first frame pattern calculation unit 122 serves to calculate a 3D pattern on the basis of the frame data transmitted from the video frame extraction unit 121. The first frame pattern calculation unit 122 of the present invention is designed to independently process specific frames, thereby improving real-time conversion speed.

The first frame pattern calculation unit 122 organizes the converted pattern data based on a log and transmits the organized pattern data to the stereoscopic video output unit 130. In conventional pattern conversion methods, a problem of frame order being mixed up may occur during the continuous frame conversion process, but in the present invention, this problem may be prevented by utilizing the log data and more precise pattern data may be generated.

The first frame pattern calculation unit 122 may utilize a graphics processing unit (GPU) parallel computation method to optimize a pattern conversion speed. In conventional systems, central processing unit (CPU)-based operations were dominant, limiting the operation speed, but in the present invention, it is designed to enable faster conversion through GPU accelerated operations.

Further, in the first frame pattern calculation unit 122, a pattern conversion method optimized for specific video content may be applied. For example, since general two-dimensional (2D) videos and high-resolution 3D content may require different conversion methods, the first frame pattern calculation unit 122 may automatically analyze these differences and apply the optimal conversion algorithm.

Lastly, the first frame pattern calculation unit 122 may cooperate with the second frame pattern calculation unit 123 to process the data in an alternating method, thereby improving real-time 3D conversion performance.

### Second Frame Pattern Calculation Unit 123

A second frame pattern calculation unit 123 serves to calculate a 3D pattern on the basis of the frame data transmitted from the video frame extraction unit 121. The second frame pattern calculation unit 123 is designed to process in an alternating manner with the first frame pattern calculation unit 122 so that the computational load may be distributed and the real-time conversion speed may be maximized. In conventional systems, there were many ways to utilize a single pattern conversion module, which could cause a bottleneck in the process of converting high-resolution and high-speed frames, but the second frame pattern calculation unit 123 of the present invention solves this problem by linking with the first frame pattern calculation unit 122.

The second frame pattern calculation unit 123 is designed to independently process the frame data received in an alternating manner from the video frame extraction unit 121. For example, the video frame extraction unit 121 may operate in a manner of transmitting even-numbered frames to the first frame pattern calculation unit 122 and transmitting odd-numbered frames to the second frame pattern calculation unit 123. Accordingly, more frames may be converted within the same time, and the real-time 3D pattern conversion speed may be increased.

The second frame pattern calculation unit 123 includes a correction algorithm to minimize data loss or distortion that may occur during the pattern conversion process. In general, during the process of generating a 3D image pattern, elements such as depth information or shading according to light sources may affect the conversion quality. In the present invention, these elements are precisely analyzed and a correction algorithm is applied so that the pattern conversion of each frame may maintain the characteristics of the original video as much as possible.

Further, in the second frame pattern calculation unit 123, a GPU-based parallel computation method may be applied to optimize the pattern conversion speed. In conventional CPU-based computation methods, the data processing speed is limited, but in the present invention, a plurality of pattern conversion operations may be performed simultaneously by utilizing the high-speed parallel computing function of a GPU. Accordingly, high-resolution videos with 4 K or 8 K resolution may also be converted into 3D patterns in real time.

Lastly, the second frame pattern calculation unit 123 performs a function to organize the converted pattern data based on a log and transmit the organized pattern data to the stereoscopic video output unit 130. Each frame includes time information and pattern conversion information, and thus the stereoscopic video output unit 130 accurately recognizes the frame order and smoothly output continuous 3D videos. The second frame pattern calculation unit 123 of the present invention maintains the consistency of video output through the log-based data sorting function and enables more stable 3D video implementation.

Precise pattern data generation method applied to first frame pattern calculation unit 122 and second frame pattern calculation unit 123

In the present invention, the first frame pattern calculation unit 122 and the second frame pattern calculation unit 123 serve to generate precise pattern data for implementing high-resolution 3D videos. To this end, an algorithm for generating an optimal pattern based on the data received from the pattern conversion unit 120 is applied, and the pattern data is processed to be converted into an accurate stereoscopic video in the display panel 132. Three examples of a precise pattern data generation method are as follows.

### Example 1: Spatial Frequency-Based Pattern Generation Method

A spatial frequency-based pattern generation method is a method of generating 3D patterns in a frequency domain using the Fourier transform. This method works by converting original video data into a spatial frequency domain and adjusting specific frequency components to enhance the sense of depth in a 3D video. The advantage of utilizing spatial frequency transform is that noise may be reduced and more precise patterns may be generated.

In this method, an input 2D video is converted into a frequency domain using discrete Fourier transform (DFT) and fast Fourier transform (FFT) algorithms. Thereafter, by performing a filtering process for amplifying or suppressing specific spatial frequency components, the data is converted into a data format appropriate for a 3D pattern. For example, emphasizing high-frequency components forms sharper patterns, while emphasizing ow-frequency components forms softer patterns.

The spatial frequency-based pattern generation method is frequently utilized in holographic displays and light field display technologies. Representatively, Massachusetts Institute of Technology (MIT)'s Digital Holography Laboratory is researching pattern generation methods using the Fourier transform and applying the pattern generation methods to actual holographic display systems.

In the present invention, the first frame pattern calculation unit 122 and the second frame pattern calculation unit 123 may independently perform the Fourier transform and apply inter-frame spatial frequency correction to generate a clearer 3D pattern. Accordingly, the resolution of holographic videos may be increased, and the precision of patterns may be maximized.

The spatial frequency-based pattern generation method may be implemented in software environments such as MATLAB, OpenCV, and TensorFlow. In MATLAB, frequency transformation and filtering are possible using the FFT, and in OpenCV, pattern data may be generated using the Fourier transform. Further, it is possible to train optimal patterns by utilizing TensorFlow's convolutional neural network (CNN)-based model.

### Example 2: Deep Learning-Based Pattern Generation Method

A deep learning-based pattern generation method is a method of training and automatically optimizing 3D patterns using an artificial neural network (ANN). This method may allow a neural network that has trained on a large amount of pattern data to generate optimal patterns for new input data.

In the present invention, a method of generating pattern data using a CNN and a generative adversarial network (GAN) may be applied. A CNN serves to analyze an original 2D video to extract characteristics necessary for 3D pattern conversion, and a GAN serves to generate new patterns on the basis of trained data.

The deep learning-based pattern generation method is a cutting-edge technology being researched by NVIDIA, Google, Facebook AI Research, and others, and is demonstrating high performance in 3D data generation and conversion. In particular, NVIDIA's StyleGAN and Pix2Pix models may be useful for converting 2D data into 3D data. In the present invention, based on this model, the first frame pattern calculation unit 122 and the second frame pattern calculation unit 123 may independently perform deep learning and automatically generate a pattern appropriate for each frame.

This method allows a trained model to automatically analyze input video data to generate optimal patterns and has the advantage of being much more precise and capable of real-time processing than conventional manual adjustment methods. Further, applicability is high because optimal 3D patterns may be applied in various environments.

In the present invention, a function to train deep learning models and generate patterns in software environments such as TensorFlow, PyTorch, OpenCV, and NVIDIA CUDA may be included. Utilizing these technologies may improve real-time pattern conversion speeds and enable more precise implementation of complex 3D patterns.

### Example 3: Wavefront Phase Modulation-Based Pattern Generation Method

A wavefront phase modulation-based pattern generation method is a method of adjusting phase information of light to form optimal patterns and may implement more precise 3D effects by utilizing laser interference patterns.

In this method, a spatial light modulator (SLM) may be used to adjust phase information in real time, and accordingly, desired patterns may be dynamically generated. For example, the SLM may individually adjust the phase of light according to input pattern data, and accordingly, form optimal 3D patterns.

The wavefront phase modulation-based pattern generation method is utilized in holographic display and optical computing technologies. Representatively, precise patterns may be generated using SLM devices developed by companies such as Holoeye, Meadowlark Optics, Hamamatsu, etc. In the present invention, by utilizing this SLM technology, the first frame pattern calculation unit 122 and the second frame pattern calculation unit 123 may perform phase modulation appropriate for each frame, and accordingly, more precise patterns may be generated.

This method is particularly powerful in applications requiring high resolution and precision. This is because, unlike conventional simple pattern generation methods, more delicate 3D patterns may be implemented by utilizing the interference and diffraction effects of light. Accordingly, it is possible to improve the quality of holographic displays and implement more realistic 3D videos.

In the present invention, the wavefront phase modulation-based pattern method may be performed by utilizing SLM control software based on MATLAB, LabVIEW, and C++. Applying this technology enables real-time pattern adjustment and the generation of optimal 3D effects in real time.

In this way, in the present invention, by utilizing three precise pattern generation methods such as the spatial frequency-based pattern generation method, the deep learning-based pattern generation method, and the wavefront phase modulation-based pattern generation method, the pattern data generated by the first frame pattern calculation unit 122 and second frame pattern calculation unit 123 may be generated with greater precision. Accordingly, it is possible to maximize the resolution of digital holographic display systems and provide immersive 3D videos.

### Specific Configuration and Role of Stereoscopic Video Output Unit 130

The stereoscopic video output unit 130 serves to implement a digital holographic 3D video on the basis of the pattern data transmitted from the pattern conversion unit 120. The stereoscopic video output unit 130 of the present invention is composed of a display housing 131, a display panel 132, and a light supply unit 133 and is designed so that the components may be organically combined to provide an optimal 3D stereoscopic effect. Conventional digital holographic display systems have limitations in maximizing a stereoscopic effect, but in the present invention, a more natural 3D effect may be provided through precise data linkage with the pattern conversion unit 120.

The stereoscopic video output unit 130 is designed to implement real-time 3D videos based on sequential processing of the pattern data. The 3D pattern data converted by the pattern conversion unit 120 is transmitted to the display panel 132, and a video is implemented on the display panel 132 on the basis of the pattern data. In this process, the light supply unit 133 may provide backlight to the display panel 132, thereby enabling the formation of a clearer stereoscopic video.

The stereoscopic video output unit 130 is designed with a modular structure to support display panels 132 of various sizes and shapes. In general, digital holographic display systems often use fixed display panels of a specific size, and thus it is difficult to provide a customized environment that meets the user's needs. The stereoscopic video output unit 130 of the present invention may adjust a mounting structure inside the display housing 131 so that display panels of various sizes may be mounted.

The stereoscopic video output unit 130 is also designed to be adjustable according to the user's viewing environment. For example, a function to adjust the brightness and contrast ratio of the display panel 132 may be provided so that the user may enjoy optimal 3D videos according to his/her desired environment. Further, the stereoscopic effect of the 3D video may be further emphasized by adjusting the intensity of a light source of the light supply unit 133, and a function to adjust the color of the video as necessary may be included.

Lastly, the stereoscopic video output unit 130 is designed for easy maintenance and upgrades. The display panel 132 and the light supply unit 133 may be removed and replaced according to the user's needs, and are configured so that, when more advanced display technology is applied in the future, the display technology may be applied to conventional systems without separate system changes. Accordingly, the user may easily manage the system while continuously maintaining the optimal quality of the 3D video.

### Display Housing 131

The display housing 131 serves to support and protect each component of the stereoscopic video output unit 130 and is designed so that the display panel 132 and the light supply unit 133 may be mounted therein. Conventional digital holographic display systems have an integrated structure, and thus components replacement and maintenance often difficult often difficult. In the present invention, the display housing 131 is designed with a modular structure so that internal components may be easily replaced and adjusted to fit the user environment.

The display housing 131 is formed to have a box-shaped structure with a constant internal volume, and has a fixed slot provided inside to allow the display panel 132 to be detached. Accordingly, the display housing 131 may be easily mounted and replaced according to the size and type of the display panel 132 and allow the user to select various types of panels as necessary.

Further, a space in which the light supply unit 133 may be mounted is provided inside the display housing 131. The light supply unit 133 serves to provide backlight to the display panel 132 and is designed to be placed in an optimal position inside a housing to provide uniform lighting across the entire panel.

The display housing 131 may be manufactured in various forms according to the user's environment, such as a wall-mounted form, a stand-alone form, a portable form, etc. Further, a waterproof and dustproof function for allowing the user to use the digital holographic display in outdoor environments may be included.

Lastly, the display housing 131 may be made of a durable material to ensure long-term use. The display housing 131 is designed to maintain a stable structure while maintaining a light weight by utilizing a metal or special plastic material that is resistant to external impact.

### Display Panel 132

The display panel 132 is a key component that implements 3D videos on the basis of the pattern data transmitted from the pattern conversion unit 120. The display panel 132 is one important element that determines the performance of a digital holographic display, and a precise design is applied to enable high-resolution pattern output.

The display panel 132 is basically composed of a main pattern generation panel 132a and an additional pattern generation panel 132b, and the two panels are arranged overlapping each other to enable more precise 3D patterns to be implemented. Compared to conventional single panel methods, the display panel 132 of the present invention may provide a more detailed stereoscopic effect and allow the resolution of the 3D video to be further improved.

The display panel 132 may sort and output pattern data based on a log, thereby enabling a 3D video to be smoothly implemented. Unlike general 2D displays, 3D videos based on pattern data require precise pattern sorting, and thus the display panel 132 of the present invention may apply precise pattern matching technology to implement a 3D video without distortion.

Further, the display panel 132 is designed to provide optimal 3D effects according to the user's viewing distance and angle. For example, the display panel 132 with an auto-focus adjustment function may detect the user's position and automatically adjust the focal length of the 3D video, thereby allowing the user to experience an optimal stereoscopic effect at any position.

Lastly, the display panel 132 is manufactured in consideration of energy efficiency. Conventional high-resolution display panels may have the disadvantage of high power consumption, but in the present invention, a panel that can operate at low power may be applied, and thus it is possible to minimize power consumption while outputting high-quality 3D videos.

### Main Pattern Generation Panel 132a

The main pattern generation panel 132a is a key component of the display panel 132 and serves to form a basic pattern of a 3D video on the basis of the pattern data transmitted from the pattern conversion unit 120. The main pattern generation panel 132a of the present invention is responsible for a key structure of a holographic video and is designed so that the converted frame data may be precisely sorted. Unlike conventional 2D display panels, the main pattern generation panel 132a may form a specific optical pattern so that the user may perceive a stereoscopic effect differently according to the user's field of view.

The main pattern generation panel 132a may generate patterns using SLM technology. An SLM is a device that forms 3D patterns by reflecting or transmitting digitally modulated light and is widely used in conventional laser-based holographic systems. In the main pattern generation panel 132a of the present invention, by applying SLM technology, a pattern modulated in real time according to the data transmitted from the pattern conversion unit 120 may be output. Accordingly, it is possible to implement precise holographic effects in which the patterns are only visible from certain angles.

Further, in the main pattern generation panel 132a, micro lens array (MLA) technology may be applied. An MLA is a structure in which thousands of tiny lenses are arranged and serves to refract light in a specific direction. The main pattern generation panel 132a of the present invention may utilize this MLA structure to recognize different patterns according to the user's field of view. For example, by adjusting the panel so that different images are visible when the user views the panel from the left or right, a more natural 3D effect may be provided.

The main pattern generation panel 132a utilizes liquid crystal modulation technology to enable more precise pattern formation. Similar to conventional liquid-crystal display (LCD) panels, when a specific voltage is applied, the arrangement of liquid crystals may be changed so that the direction of light refraction may be adjusted, and accordingly, the data transmitted from the pattern conversion unit 120 may be converted into a more detailed pattern. For example, a method of adjusting the arrangement of liquid crystals in real time may be applied to adjust the depth of a holographic image.

In the main pattern generation panel 132a, a Fresnel lens structure may be further applied. A Fresnel lens has the advantage of maintaining a thin thickness while providing a refractive effect similar to that of a general convex lens. The main pattern generation panel 132a of the present invention includes such a Fresnel lens structure, and thus it is possible to reduce loss of unnecessary light when forming patterns and implement clearer 3D videos.

Further, the main pattern generation panel 132a of the present invention may display the pattern data to be divided in multiple layers by applying a multi-layered structure. For example, when a hologram is generated, a pattern responsible for the basic structure and a pattern representing detailed depth information are generated on separate layers, and thus a more precise 3D effect may be achieved. Accordingly, it is possible to provide a more precise stereoscopic effect than conventional single-layer pattern panels and also increase the clarity of the video.

Lastly, in the main pattern generation panel 132a, a phase modulation method combined with digital holographic technology may be applied. Unlike conventional simple pattern generation methods, the phase modulation method may provide more natural 3D videos by optically adjusting the patterns. For example, by adjusting phase information in real time using laser light of a specific wavelength, the sense of depth may be expressed more precisely, thereby providing more immersive 3D videos.

### Detailed Description of SLM Technology

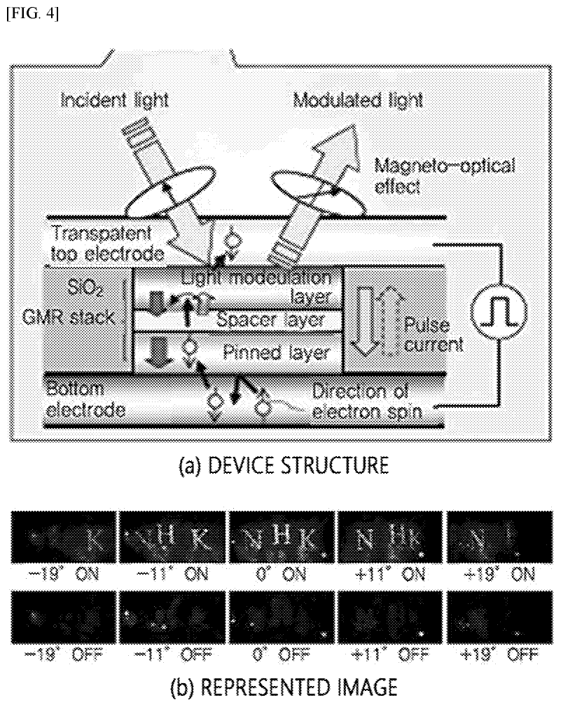

An SLM is a device that adjusts a spatial distribution of light and is used in various optical applications. The SLM may modulate the amplitude, phase, or polarization of light according to an input signal, thereby generating a desired pattern or image. Due to these properties, the SLM plays an important role in digital holographic displays, optical computation, optical communications, laser beam steering, and augmented reality (AR) and virtual reality (VR) systems (see FIG. 4).

The fundamental principle of the SLM is to adjust the characteristics of light at each pixel level. To this end, liquid crystal-based modulation elements or reflective elements such as digital micromirror devices (DMDs) are utilized. A liquid crystal-based SLM adjusts the phase or amplitude of light by changing the arrangement of liquid crystals in response to electrical signals, and may generally provide high resolution. On the other hand, a micromirror-based SLM operates by tilting microscopic mirrors to change the direction of reflection, and extremely high-speed modulation is possible.

Representative types of SLMs include liquid crystal on silicon (LCoS) and DMDs. An LCoS is a structure in which liquid crystals are placed on a silicon substrate to enable precise modulation of light phase through fine voltage adjustment. This method is used in holographic displays, optical processing, and high-resolution imaging systems. On the other hand, a DMD is a structure designed so that millions of micromirrors can tilt independently and is mainly used in digital projectors and optical communication systems that require a fast response speed.

The SLM plays a particularly important role in digital holographic systems. Computer-generated holographic patterns may be displayed on the SLM and illuminated with laser light to generate a 3D image. Unlike conventional 2D displays, this method provides excellent depth perception and the advantage of being able to view 3D videos from multiple angles. Further, this method is used to precisely adjust laser beams in optical trapping techniques and in experiments such as moving specific particles to a desired location.

SLM technology is becoming an essential component in next-generation digital displays, holography, and AR and VT systems. SLMs, with their high resolution and fast response speed, enable more realistic 3D video implementation, and in the optical communication field, the SLMs may also be applied to high-speed data transmission technologies using multi-channel beamforming and phase modulation. Advances in these technologies are expected to contribute to improving the performance of optical-based digital systems in various industrial fields in the future.

### Detailed Description of Phase Modulation Technology Combined With Digital Holographic Technology

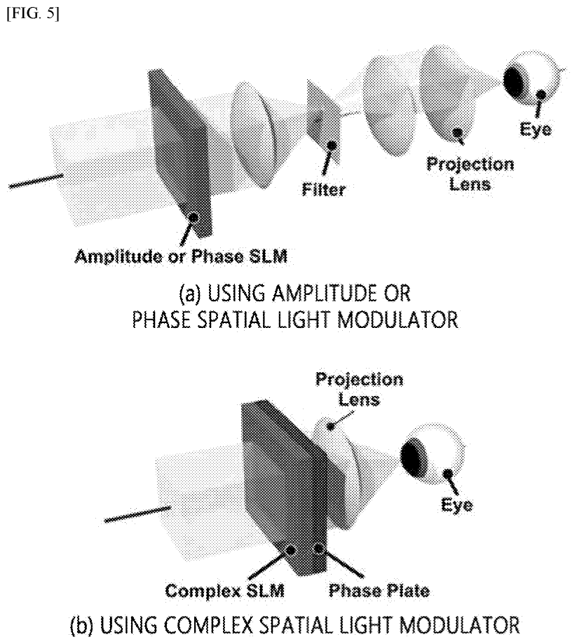

The digital holographic technology is an innovative method for reproducing 3D videos and utilizes phase modulation to implement more precise and vivid 3D images. Phase modulation is a technology for adjusting the phase of light to form a desired wavefront, and accordingly, stereoscopic video information may be accurately transmitted (see FIG. 5).

The phase modulation method is implemented using a device such as an SLM. An SLM is a device that allows each pixel to individually adjust the phase of light according to an input signal and plays a key role in digital holographic systems. When computer-generated holographic patterns are transmitted to the SLM, the SLM modulates the phase of light according to the patterns, and a 3D video is reproduced.

The main advantages of digital holographic technology using a phase modulation method are its high resolution and accuracy. By precisely adjusting the phase of light, even subtle depth information may be expressed, and thus viewers may enjoy more realistic 3D videos from various angles. Further, the phase modulation is more energy efficient than amplitude modulation, and thus it is advantageous for implementing bright and clear videos.

This technology is being utilized in various fields, such as medical imaging, scientific research, entertainment, etc. For example, in the medical field, this technology provides precise 3D organ models for surgical planning, and in the entertainment industry, this technology is used to implement immersive VR content. Further, in the education field, this technology contributes to enhancing learning effect by visually transmitting complex structures and concepts.

The combination of digital holographic technology and phase modulation opens up new possibilities for 3D video implementation. With future improvements in SLM performance and advancements in computing technology, even more sophisticated and realistic holographic displays are expected.

### Additional Pattern Generation Panel 132b

The additional pattern generation panel 132b is placed on a rear surface of the main pattern generation panel 132a and serves to further enhance a stereoscopic effect of a 3D video by forming auxiliary patterns. The additional pattern generation panel 132b of the present invention may interact with the main pattern generation panel 132a, which is responsible for forming a basic pattern, and form auxiliary patterns according to the data provided by the pattern conversion unit 120 to provide an optimal 3D effect.

The additional pattern generation panel 132b may apply multi-layer holographic pattern technology to enable more detailed adjustment of depth information. Conventional 3D display systems often generate patterns from a single layer, and thus have limitations in expressing a complex stereoscopic effect. In the present invention, by utilizing the additional pattern generation panel 132b, patterns having different depths may be output in an overlapping manner, thereby enabling a more realistic 3D effect to be implemented.

Further, in the additional pattern generation panel 132b, a pattern conversion technology using the polarization characteristics of light may be applied. Polarizing filters may be used to adjust patterns so that only certain directions of light pass through, and thus more precise 3D videos may be implemented. For example, when patterns that are visible only at certain depths is generated using polarization, a stereoscopic effect may be more clearly revealed as the user's viewpoint changes.

The additional pattern generation panel 132b may include a pattern correction function using phase differences. In conventional 3D pattern generation methods, depth information is often simply hierarchized, which can lead to pattern distortion at a certain time point. The additional pattern generation panel 132b of the present invention may address this problem by generating auxiliary patterns on the basis of phase differences.

Further, in the additional pattern generation panel 132b, a pattern adjustment technology including a color filter may be applied. Unlike conventional monochrome holographic systems, the additional pattern generation panel 132b of the present invention may include RGB color filters to enable more vivid 3D videos to be implemented. For example, in a color holographic video, the wavelengths of each color may be refracted differently, and to correct this, the additional pattern generation panel 132b finely adjusts the pattern of a specific color to enable more uniform color expression.

Lastly, the additional pattern generation panel 132b includes a dynamic pattern adjustment function to allow the intensity of the pattern to be automatically adjusted according to the video content. For example, in videos containing fast-moving objects, additional patterns may be generated to increase clarity, while in static videos, more natural pattern changes may be applied. Accordingly, an optimal 3D effect may be provided in various types of content.

As described above, the digital holographic display system of the present invention solves various problems raised in the related art and enables implementation of more improved 3D stereoscopic videos. Conventional digital holographic display systems have problems such as difficulty in real-time video conversion, only specific video data to be processed, and limited stereoscopic effect due to insufficient precision of 3D patterns. The present invention has been improved to perform immediate 3D video conversion using various input sources and form more sophisticated patterns through organic linkage of the data input unit 110, the pattern conversion unit 120, and the stereoscopic video output unit 130.

First, the digital holographic display system of the present invention solves the delay problem of conventional systems by maximizing real-time video conversion performance. In the related art, only pre-produced holographic videos can be output, and the function to immediately convert videos captured in real time or data input from outside is inadequate. In the present invention, the data input unit 110 may immediately accommodate captured videos, stored data, and real-time broadcast data, the pattern conversion unit 120 may rapidly convert the captured videos, the stored data, and the real-time broadcast data into 3D patterns and transmit the converted 3D patterns to the stereoscopic video output unit 130, and thus videos that change in real time may be immediately converted into 3D videos. Accordingly, user experience may be improved, and the present invention may be used in various fields such as real-time broadcasting, remote meetings, live events, etc.

Second, the present invention significantly improves data compatibility so that various types of input data may be processed. In conventional systems, only data in specific video formats or with a fixed resolution may be processed, resulting in a lack of connectivity with various devices. The data input unit 110 of the present invention may support wired and wireless connections so that a wide range of data, including not only shooting devices such as cameras, camcorders, and CCTVs, but also stored image and video files and real-time broadcast data, may be accommodated. Further, the pattern conversion unit 120 may automatically convert and process various video formats so that various types of video data may be converted directly without a separate conversion process.

Third, the pattern conversion unit 120 of the present invention has improved the speed and accuracy of 3D pattern conversion by applying a high-speed parallel computation method. In conventional systems, the data processing speed is low during the process of converting 3D patterns, resulting in delays when high-resolution videos or fast-moving object are converted. In the present invention, the first frame pattern calculation unit 122 and the second frame pattern calculation unit 123 of the pattern conversion unit 120 operate alternately to distribute the computational load, and GPU-based parallel computing is applied to maximize real-time 3D pattern conversion performance. Accordingly, clearer and smoother 3D videos may be implemented.

Fourth, the stereoscopic video output unit 130 of the present invention solves the problem of conventional 3D video quality by improving a stereoscopic effect and the sense of depth. In conventional digital holographic display systems, the precision of patterns is low and optical distortion often occurs, resulting in a lack of stereoscopic effect. In the present invention, the display panel 132 is composed of the main pattern generation panel 132a and the additional pattern generation panel 132b so that a more sophisticated 3D patterns may be formed, and the stereoscopic effect of the 3D video may be significantly improved by applying a phase modulation method and a multi-layer pattern forming technology. Accordingly, the user may enjoy more natural 3D videos, and the present invention may be applied to various fields such as industrial simulation, medical imaging, educational content, etc.

Fifth, the light supply unit 133 of the present invention includes local dimming and color temperature control functions, thereby improving the contrast ratio and color of 3D videos through lighting optimization. Conventional backlight systems only perform a simple function for providing lighting, which causes problems such as a lack of depth in 3D videos and limited color expression. The light supply unit 133 of the present invention is designed to precisely control the light-emitting diode (LED) backlight so that brightness and color temperature may be adjusted in specific regions and more vivid 3D videos may be provided by utilizing RGB lighting. Accordingly, the user may experience an optimized 3D viewing environment and use a more immersive digital holographic display.

Sixth, the digital holographic display system of the present invention applies a modular design to improve maintainability and expandability. Conventional integrated display systems have had a problem that certain components thereof are difficult to replace due to damage or technological advancements. In the present invention, a detachable structure is applied inside the display housing 131 so that major components thereof such as the display panel 132, the light supply unit 133, and the like may be easily replaced or upgraded. Accordingly, the system may be kept up to date even after long-term use and may be flexibly utilized in various applications.

Lastly, the present invention implements a user-friendly system to increase the accessibility of digital holographic technology. Conventional systems are difficult to set up unless the user is an expert, and the operation process is complex, making it difficult for general users to easily utilize them. In the present invention, an automatic pattern conversion function, an environment detection-based brightness control function, an intuitive interface, etc. may be applied so that even general users may easily utilize digital holographic technology. Accordingly, the present invention may be utilized in various fields such as home 3D displays, a medical diagnostic device, online education, VR and AR content, and may contribute to the popularization of digital holographic technology.

Consequently, the digital holographic display system of the present invention effectively solves the problems of conventional systems, such as insufficient real-time conversion performance, data compatibility issues, reduced 3D pattern precision, lighting optimization issues, and maintenance difficulties, and is improved to provide clearer and more immersive 3D videos. Accordingly, the digital holographic display system of the present invention may be utilized in various industrial and consumer environments, and is expected to open up new possibilities for digital holographic technology.

As described above, according to the digital holographic display system of the present invention, by including a data input unit, a pattern conversion unit, and a stereoscopic video output unit of a specific structure, it is possible to easily output a 3D stereoscopic video intended to be implemented after inputting an image prepared according to a user or operator's intentions, output a 3D stereoscopic image or video intended to be implemented upon photographing or video recording, output a 3D stereoscopic video upon loading a pre-stored image or video, and output a 3D stereoscopic video upon input of image and video data received through real-time broadcasting, thereby easily providing a 3D stereoscopic video without the help of an expert in digital holography.

In the detailed description of the present invention above, only specific embodiments thereof have been described. However, it should be understood that the present invention is not limited to the specific forms described in the detailed description, but rather includes all modifications, equivalents, and alternatives falling within the spirit and scope of the present invention defined by the appended claims.

That is, the present invention is not limited to the above-described specific exemplary embodiments. Those skilled in the art may variously modify the present invention without departing from the gist of the present invention claimed by the appended claims and the modifications are within the scope of the claims.

What is claimed is:

1. A digital holographic display system comprising:
a data input unit (110) configured to accommodate image and video data input according to a user's intention and transmit the accommodated image and video data to a pattern conversion unit (120);
the pattern conversion unit (120) configured to calculate pattern data for a stereoscopic image corresponding to the accommodated data and transmit the calculated pattern data to a stereoscopic video output unit (130) in real time; and
the stereoscopic video output unit (130) configured to form a pattern on a display panel (132) according to the pattern data transmitted in real time from the pattern conversion unit (120) and provide backlight to the display panel (132) to implement a three-dimensional (3D) stereoscopic video,
wherein the data input unit (110) includes:
a captured data accommodating unit (111) that accommodates data captured through the user's video detection sensor, camera, camcorder, shooting device, closed-circuit television (CCTV), or video recording device and transmits the accommodated data to the pattern conversion unit (120) through a wired transmission cable or a wireless communication module;
a stored data accommodating unit (112) that accommodates image and video data through the user's data storage medium or data storage device and a wired transmission cable or a wireless communication module and transmits the accommodated image and video data to the pattern conversion unit (120); and
a broadcast data accommodating unit (113) that is connected to a broadcast medium or broadcast output device set or connected by the user through a wired transmission cable or a wireless communication module and accommodates the image and video data received in real time from the connected broadcast medium or broadcast output device to transmit the accommodated image and video data to the pattern conversion unit (120),
the pattern conversion unit (120) includes:
a video frame extraction unit (121) that extracts still images in a preset number of frames per second in a video playback order from the data received from the data input unit (110), assigns a video playback order-related log to each extracted image, and alternately transmits the extracted still images to which the log is assigned to the first frame pattern calculation unit (122) and the second frame pattern calculation unit (123) at a cycle of one second;
a first frame pattern calculation unit (122) that calculates pattern data corresponding to the images transmitted from the video frame extraction unit (121) and transmits the calculated pattern data to the stereoscopic video output unit (130) according to the log; and
a second frame pattern calculation unit (123) that calculates pattern data corresponding to the images transmitted from the video frame extraction unit (121) and transmits the calculated pattern data to the stereoscopic video output unit (130) according to the log,
the stereoscopic video output unit (130) includes:
a display housing (131), which has a box-shaped structure having an internal accommodating space of a predetermined volume, in which the display panel (132) is detachably mounted on an internal front surface thereof, a backlight is detachably mounted on an internal rear surface thereof, and a structure that allows a mounting structure to change in response to widths and lengths of the display panel (132) and the backlight is embedded, and which has a structure in which the data input unit (110) and the pattern conversion unit (120) are mounted therein;
the display panel (132) that is detachably mounted on the internal front surface of the display housing 131 and forms a pattern by sequentially accommodating the pattern data alternately transmitted from the first frame pattern calculation unit (122) and the second frame pattern calculation unit (123) of the pattern conversion unit (120) according to the log; and
a light supply unit (133) that is mounted on the internal rear surface of the display housing (131), sequentially accommodates the pattern data alternately transmitted from the first frame pattern calculation unit (122) and the second frame pattern calculation unit (123) of the pattern conversion unit (120) according to the log, and outputs backlight corresponding to a pattern formed on the display panel (132) to provide the backlight to the display panel (132), and
the display panel (132) includes:
a main pattern generation panel (132a) that is detachably mounted on the internal front surface of the display housing (131), is placed to overlap an additional pattern generation panel (132b), and sequentially accommodates the pattern data transmitted from the first frame pattern calculation unit (122) according to the log to form a pattern; and
the additional pattern generation panel (132b) that is detachably mounted on the internal front surface of the display housing (131), is placed to overlap a rear surface of the main pattern generation panel (132a), and sequentially accommodates the pattern data transmitted from the second frame pattern calculation unit (123) according to the log to form a pattern.
